(19) United States
(12) Patent Application Publication
(10) Pub. No.: US 2012/0192977 A1
(43) Pub. Date: Aug. 2, 2012

(54) DUCK-BILLED CHECK VALVE

(76) Inventor: YU-YAO TSAO, New Taipei City (TW)

(21) Appl. No.: 13/015,521

(22) Filed: Jan. 27, 2011

(51) Int. Cl. F16K 15/14

(52) U.S. Cl. 137/843

(57) ABSTRACT

A duck-billed check valve includes a fitting tube, which receives a duck-billed tube fit therein. The duck-billed tube has a valve opening that is deformable for opening and an insertion opening. The insertion opening receives a liquid inlet tube formed in a lid of a waste liquid collection bottle to fit therein, whereby when the liquid inlet tube is fit into the duck-billed tube, the valve opening is compressed to deform and thus open. When the liquid inlet tube is separated from the duck-billed tube, the valve opening is not compressed and thus set in a closed condition. With such a deformed-to-open arrangement of the valve opening, when the waste liquid collection bottle is removed for replacement, liquid is prevented from leaking through the end of a pipe detached from the waste liquid collection bottle and the potential risk of infection of cleaning personal in cleaning liquid leakage is eliminated.

### (A) TECHNICAL FIELD OF THE INVENTION

The present invention generally relates to a duck-billed check valve, which comprises a valve structure that helps blocking an end of a pipe that is detached from a waste liquid collection bottle so as to eliminate spill and leakage of liquid in a process of replacing the waste liquid collection bottle.

### (B) DESCRIPTION OF THE PRIOR ART

Some therapeutic treatments, such as dental treatment or medical and surgical treatments, require extraction of body fluid from a patient, such as blood, pus, or unidentified liquid. The extraction of liquid is often done with vacuum suction and the liquid so extracted is collected in a waste liquid collection bottle. Once the waste liquid collection bottle is filled to a predetermined extent, the waste liquid collection bottle is replaced by an empty one.

The currently used way of arranging the waste liquid collection bottles is to arrange a number of waste liquid collection bottles in a circumferentially distributed form in a movable stand. Pipes are then connected between top openings of the waste liquid collection bottles.

To replace a waste liquid collection bottle that is filled with the collected waste liquid, the waste liquid collection bottle is separated from the pipe to allow the waste liquid collection bottle to be removed out of the stand. Then an empty bottle is placed into the stand and connected to the pipe that is detached from the just removed bottle to complete the process of bottle replacement.

However, in the replacement of the filled waste liquid collection bottle, the pipe that is separated from the bottle to be replaced is still connected, at an opposite, to another waste liquid collection bottle, which may be partially filled with waste liquid. If it is still in a vacuum suction operation, then the end of the pipe that is to be connected to the replacement bottle is open and the waste liquid collected in said another bottle may unexpectedly discharge through the open end, which is not yet put into connection with the replacement bottle. The discharge liquid may be some kind of medical waste, which may cause undesired infection to cleaning personnel, who is cleaning the discharge liquid.

### SUMMARY OF THE INVENTION

In view of the above discussed problem, the present invention provides a duck-billed check valve that prevents spill and leakage of liquid by closing an end connected to a liquid conveyance pipe in the process of replacing a waste liquid collection bottle so as to reduce the potential risk of infection of the cleaning personnel in cleaning liquid leakage.

The primary objective of the present invention is to provide a duck-billed check valve, which is used to mount to a lid, which is mounted to a waste liquid collection bottle and forms a liquid inlet tube. The duck-billed check valve comprises a fitting tube and a duck-billed tube. The fitting tube is an L-shaped tube having two ends respectively forming a joint opening and a mounting opening. The duck-billed tube is received through the mounting opening in the fitting tube. The end of the duck-billed check valve that is inserted into the fitting tube forms a normally-closed valve opening that is selectively deformable for opening. The duck-billed tube has an opposite end forming an insertion operation for receiving the liquid inlet tube to insert therein.

With the above described structure, when the liquid inlet tube in inserted into the insertion opening of the duck-billed tube, the valve opening is compressed and thus deformed to open, whereby liquid is allowed to flow through the valve opening and the liquid inlet tube to enter the waste liquid collection bottle. To replace the waste liquid collection bottle, the liquid inlet tube is removed from the duck-billed tube, releasing the valve opening from being compressed, whereby the valve opening resumes the original form and thus set the valve opening in a closed condition to prohibit liquid from passing through the valve opening to enter the waste liquid collection bottle.

According to the present invention, in replacing the waste liquid collection bottle, the end of a liquid conveyance pipe that is separated from the waste liquid collection bottle is set in a closed condition, so that liquid is prohibited from leakage through the pipe, whereby the potential risk of infection of the cleaning personnel who cleans the liquid leakage is reduced and the health of the cleaning personnel can be protected.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view, in an exploded form, showing a duck-billed check valve according to the present invention.

FIG. 2 is a cross-sectional view showing the duck-billed check valve of the present invention in an assembled form.

FIG. 3 is a perspective view showing the condition before a duck-billed check valve of the present invention is mounted to a lid of a waste liquid collection bottle.

FIG. 4 is a cross-sectional view showing the duck-billed check valve of the present invention mounted to the lid of the waste liquid collection bottle.

FIG. 5 is a cross-sectional view showing the duck-billed check valve of the present invention detached from the lid of the waste liquid collection bottle.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

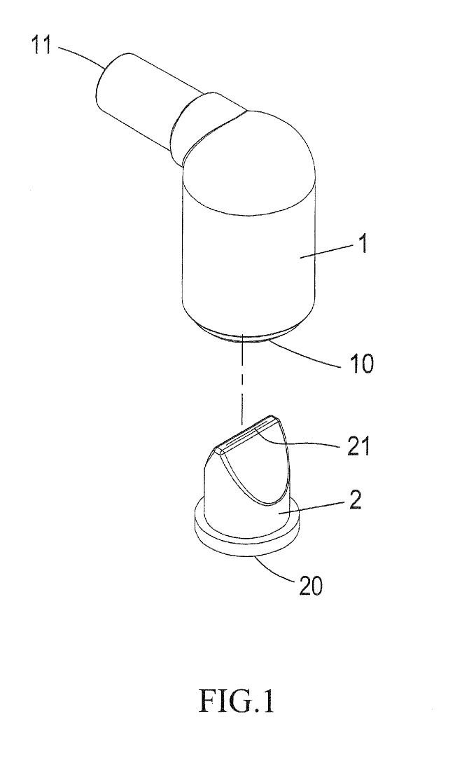

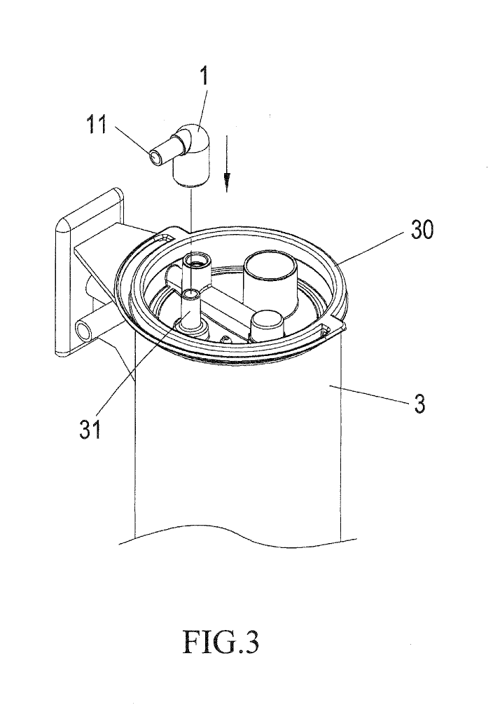

Referring to FIGS. 1 and 3, the present invention provides a duck-billed check valve, which is used in combination with a waste liquid collection bottle 3. The waste liquid collection bottle 3 has a top to which a lid 30 is mounted. The lid 30 forms a liquid inlet tube 31.

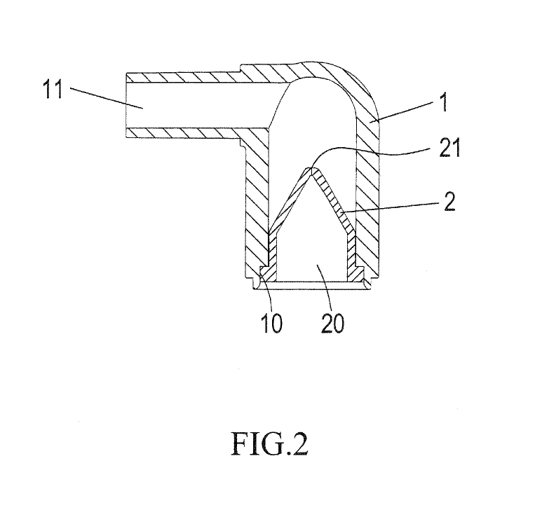

Referring to FIGS. 1 and 2, the duck-billed check valve comprises a fitting tube 1 and a duck-billed tube 2.

The fitting tube 1 has two ends respectively forming a joint opening 11 and a mounting opening 10. Preferably, the fitting tube 1 is an L-shaped tube.

The duck-billed tube 2 has an end forming an insertion opening 20 and an opposite end forming a normally closed valve opening 21, which is deformable for opening.

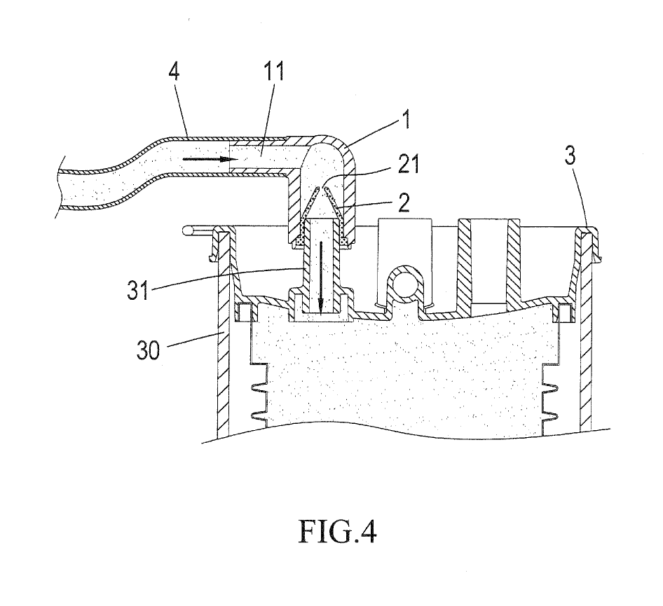

Referring to FIGS. 3 and 4, the duck-billed check valve of the present invention is connectable to with the liquid inlet tube 31 of the lid 30 of a waste liquid collection bottle 3. The liquid inlet tube 31 is insertable through the insertion opening into the duck-billed tube 2, and the valve opening 21 is thus compressed by the liquid inlet tube 31 and deformed to set the valve opening 21 in an open condition. The joint opening 11 is connectable to a pipe 4, whereby a liquid is allowed to flow through the pipe 4, the fitting tube 1, the valve opening 21 that is set in the open condition, and the liquid inlet tube 31 to enter the waste liquid collection bottle 3.

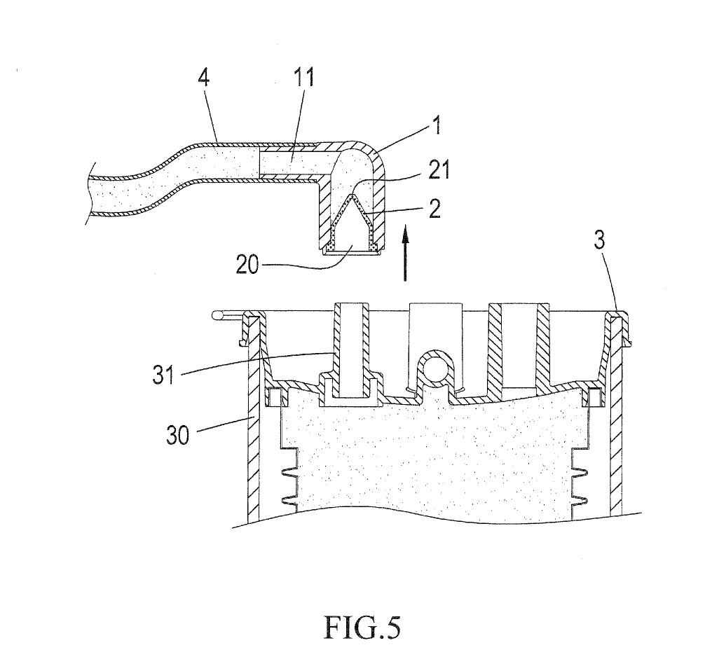

Referring to FIG. 5, when the waste liquid collection bottle 3 is filled with the liquid, the duck-billed tube 2 is detached from the liquid inlet tube 31, whereby the valve opening 21 is no longer compressed by the liquid inlet tube 31 and the valve opening 21 is allowed to resume the original form, setting the valve opening 21 in a closed condition. Liquid is prevented from passing through the closed valve opening 21, so that liquid is prevented from spill and leakage. When a replacement waste liquid collection bottle 3 is properly installed, the duck-billed tube 2 is re-connected to the liquid inlet tube 31 to once again allow the liquid to flow through the valve opening 21 into the waste liquid collection bottle 3.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A duck-billed check valve adapted to be mounted to a lid that forms a liquid inlet tube, the duck-billed check valve comprising:
a fitting tube, which two ends respectively forming a joint opening and a mounting opening; and
a duck-billed tube, which has an end forming an insertion opening and an opposite end forming a valve opening, which is normally closed and selectively deformable for opening;
wherein said opposite end of the duck-billed tube that forms the valve opening is fit through the mounting opening into the fitting tube and the insertion opening of the duck-billed tube selectively receives the liquid inlet tube to fit therein, whereby the insertion of the liquid inlet tube into the insertion opening causes the valve opening to be compressed by the liquid inlet tube and thus set in an open condition, and separation of the liquid inlet tube from the duck-billed tube releases the valve opening from being compressed by the liquid inlet tube and sets the valve opening in an open condition.

2. The duck-billed check valve according to claim 1, wherein the fitting tube comprises an L-shaped tube.

3. The duck-billed check valve according to claim 1, wherein the lid is mounted to a waste liquid collection bottle.
